(19) United States
(12) Patent Application Publication
(10) Pub. No.: US 2006/0276231 A1
(43) Pub. Date: Dec. 7, 2006

(54) Communications device, system and method

(76) Inventor: Dustin Malcom, Flower Mound, TX (US)

Correspondence Address: W. THOMAS TIMMONS;THE WHITE HOUSE ON TURTLE CREEK, 2401 TURTLE CREEK BLVD, DALLAS, TX, 75219-4760, US

(21) Appl. No.: 11/444,005

(22) Filed: May 31, 2006

Related U.S. Application Data
(60) Provisional application No. 60/687,296, filed on Jun. 3, 2005.

(51) Int. Cl. H04B 1/38; H04M 1/00

(52) U.S. Cl. 455/563

(57) ABSTRACT

A device, method, and system which allows for digital signals sent from a computer system to be interpreted as an analog signal to a radio communications device, and vise versa is disclosed. The system and method also allow for the integration of any audio source. Through this integration, users can listen to AM/FM radio audio, TV audio, and any other digital or analog input wired to the system. In one arrangement, a computer with attached microphone, a user can send an audio signal from their computer to a radio communications device. The radio communications device interprets the signal as an audio signal, and then transmits the audio signal over the radio system. The user can also listen to any audio signal wired to the device.

### CROSS-REFERENCE TO RELATED APPLICATIONS

This application is a Continuation-in-Part of Provisional Application No. 60/687,296 filed Jun. 3, 2005.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention is generally in the field of electronic communications and, in particular, the transmission of audio signals from 2-way radio, radio, television or other sources over the Internet.

2. Description of Related Art

Voice transmission over the Internet is well known, including telephone type transmission. Similarly, the use of voice-activated transmitter (VOX) Radio Interface Modules for transmission of voice over 2-way radios is well known.

Law enforcement and other emergency services have traditionally communicated with 2-way radios. Frequently, communications between police working for adjacent cities has been a problem, and communication between state law enforcement and local law enforcement has been difficult because of the need to operate on different frequencies.

### BRIEF SUMMARY OF THE INVENTION

The present invention is a device, method, and system which allows for digital signals sent from a computer system to be interpreted as an analog signal to a radio communications device, and vise versa. The system and method also allow for the integration of any audio source. Through this integration, users can listen to AM/FM radio audio, TV audio, and any other digital or analog input wired to the system. In one arrangement, a computer with attached microphone, a user can send an audio signal from their computer to a radio communications device. The radio communications device interprets the signal as an audio signal, and then transmits the audio signal over the radio system. The user can also listen to any audio signal wired to the device.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is a communications system according to the present invention; and

FIG. 2 is an alternative communications system according to the present invention.

### DETAILED DESCRIPTION OF THE INVENTION

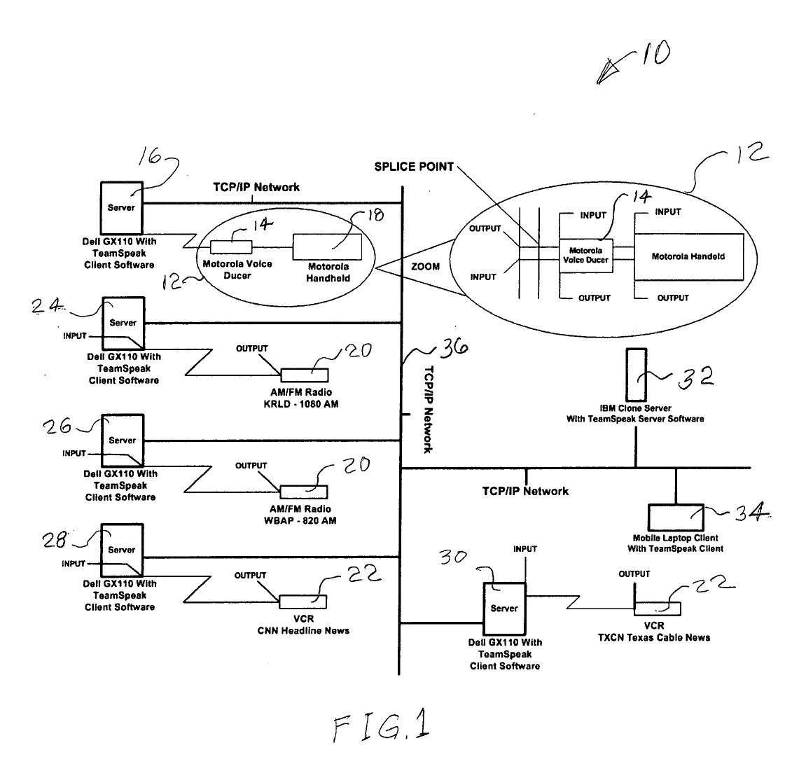

Referring now to the drawing, and in particular to FIG. 1, a communications system according to the present invention is referred to generally by reference numeral 10. Communications system 10 includes a communications device 12. Communications device 12 is created by changing the input and output configuration of any 2-way radio voice-activated transmitter (VOX) Radio Interface Module 14. Input is reversed with output by altering the wiring of the device. Input (I+ and I−) are rewired to equal output (O+ and O−). The effect is a reverse two-way communication device which accepts signals from a computer (or any digital source), which is interpreted as an analog input. Instead of the VOX Radio Interface Module receiving an audio signal from an actual person, the audio is supplied by an electrical signal from a computer, such as server 16. The VOX Radio Interface Module opens the radio channel, such as through a handheld radio 18, per its programming, and sends the audio signal over the radio system. Likewise, when a radio audio signal is submitted to the VOX Radio Interface Module, the signal is reversed to the computer, and converted from analog to digital by the device. VOX Radio Interface Module 14 is modified by removing the attached, factory-installed speaker and microphone, and adding two mini-connectors to each pair of wires. The output mini-connector is inserted into a computer soundcard's microphone port, and the input mini-connector is inserted into a computer soundcard's speaker port.

A method according to the present invention is created by altering the intention of a voice conference software called TeamSpeak. TeamSpeak is typically used for two or more parties to voice communicate over the Internet. The method challenges this paradigm by allowing voice conference with audio devices such as a hand-held 800 MHZ radios, AM/FM radio 20, a television signal 22, etc. to servers 24, 26, 28 and 30. No longer is this type of method only used for voice conference, but now allows for a private and secure method for listening and transmitting to audio sources via the Internet.

The system is created by re-wiring the input and output of various audio devices. Classically, these devices output their audio signal to an attached speaker, which is then audible to listeners in the same physical area. Using the above method and this system, users can listen to audio signals from any location in which Internet access is available. The system uses a TeamSpeak Server software application for the management of clients such as server 32, and TeamSpeak Client software for the management of audio sources. Clients, such as servers 24, 26, 28 and 30 and a mobile laptop 34, then attach to the TeamSpeak Server for audio information sharing. Any person with the proper software, configuration, and security clearance can listen to each audio source (e.g. voice, radio, television, etc) using a computer.

Voice transmissions are encoded by the TeamSpeak software, and transmitted to client computers using the network protocol TCP/IP (Transmission Control Protocol/Internet Protocol) for network 36.

Using this device, system, and method in conjunction with voice conferencing software, radio devices could be integrated together allowing for seamless communication between dissimilar radio frequencies. Further, any audio source could be wired by the above system and using the above method to create a secure conduit for information exchange. Leveraging the Internet, these audio sources could be accessible from any location on the globe.

Test Materials

One (1) TeamSpeak Voice Conferencing Server software
Five (5) TeamSpeak Voice Conferencing Client software
Five (5) Dell GX110 Computers
Five (5) Microsoft Windows 98 Second Edition Operating System software
One (1) IBM/Clone Server
One (1) Microsoft Windows NT 4.0 Operating System software
One (1) Dell Inspiron 5150 Laptop Computer
One (1) Microsoft Windows XP Professional Operating System software
One (1) Motorola MTX Hand-Held Radio (H01UCH6DB7AN NX)
VoiceDucer Radio Interface Module (BDN6671B)
Two (2) shielded gold-plated mini audio connectors
One (1) Motorola Microphone Cable (BDN6677A)
Two (2) AM/FM Radios
Two (2) Generic VCR's

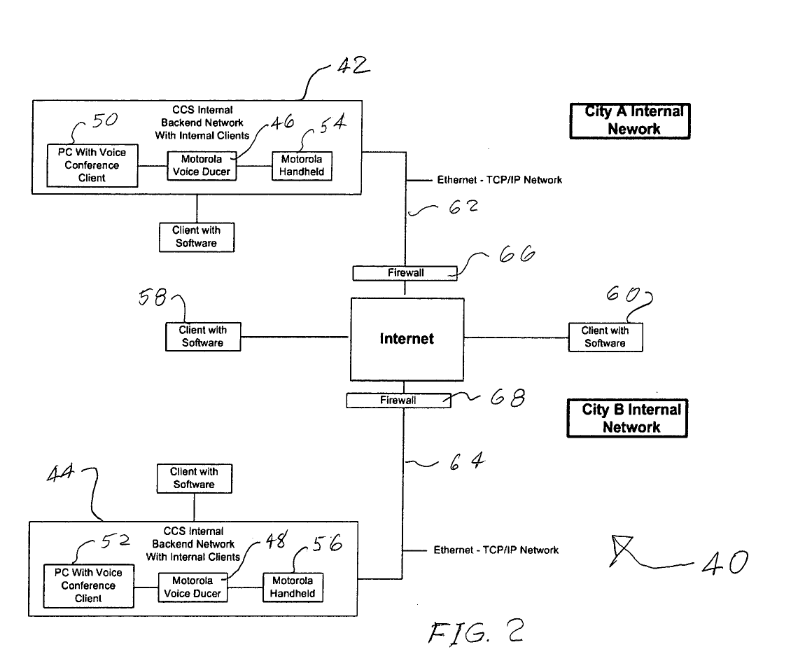

Referring now to FIG. 2, an alternative embodiment of a communication system according to the present invention is referred to generally by reference numeral 40. Communication system 40 includes two separate independent systems 42 and 44 which can be operated by two different city governments, City A and City B. Independent system 42 and independent system 44 include a communications devices as in the prior embodiment, which is created by changing the input and output configuration of any 2-way radio voice-activated transmitter (VOX) Radio Interface Module 46 and 48 respectively. Just as in the prior embodiment, input is reversed with output by altering the wiring of the device. Input (I+ and I−) are rewired to equal output (O+ and O−). The audio is supplied by an electrical signal from computers 50 and 52. The VOX Radio Interface Module opens the radio channel, such as through a handheld radios 54 and 56, per its programming, and sends the audio signal over the radio system. Likewise, when a radio audio signal is submitted to the VOX Radio Interface Module, the signal is reversed to the computer, and converted from analog to digital by the device.

A method according to the present invention is created by altering the intention of a voice conference software called TeamSpeak. TeamSpeak is typically used for two or more parties to voice communicate over the Internet. The method once again allows voice conference with audio devices such as a hand-held 800 MHZ radios, AM/FM radio, a television signal, etc. City A and City B can now have a private and secure method for listening and transmitting to audio sources via the Internet. This would allow easy cooperation between the police and fire departments of the two cities.

Once again, the system is created by re-wiring the input and output of various audio devices. Classically, these devices output their audio signal to an attached speaker, which is then audible to listeners in the same physical area. Using the above method and this system, users can listen to audio signals from any location in which Internet access is available. The system uses a TeamSpeak Server software application for the management of clients such as a main server, and TeamSpeak Client software for the management of audio sources. Clients, such as computers 50 and 52 and a mobile units such as police cars with client software 58 and 60, then attach to the TeamSpeak Server for audio information sharing. The police cars could connect through their respective city independent systems 42 and 44 instead of connecting directly as illustrated. Any person with the proper software, configuration, and security clearance can listen to each audio source (e.g. voice, radio, television, etc) using a computer. Voice transmissions are encoded by the TeamSpeak software, and transmitted to client computers using the network protocol TCP/IP (Transmission Control Protocol/Internet Protocol) for networks 62 and 64 which connect to the Internet through firewalls 66 and 68.

Using this device, system, and method in conjunction with voice conferencing software, radio devices could be integrated together allowing for seamless communication between dissimilar radio frequencies. Further, any audio source could be wired by the above system and using the above method to create a secure conduit for information exchange even between different government bodies. This would greatly simplify communication between state and local law enforcement as well as between law enforcement by adjacent cities.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting

1. A communications device comprising, in combination:
a 2-way radio; and
a voice-activated transmitter Radio Interface Module, wherein the input (I+ and I−) are rewired to equal output (O+ and O−), whereby the effect is a reverse two-way communication device which accepts signals from a computer or other digital source, which is interpreted as an analog input.

2. A communications device according to claim 1, wherein the voice-activated transmitter Radio Interface Module opens a radio channel through the 2-way radio, per its programming, and sends the audio signal over the radio system, and wherein a radio audio signal submitted to the voice-activated transmitter Radio Interface Module, the signal is reversed to the computer, and converted from analog to digital by the device.

3. A communications device according to claim 2, wherein a factory voice-activated transmitter Radio Interface Module is modified by removing the attached, factory-installed speaker and microphone, and adding two mini-connectors to each pair of wires, whereby the output mini-connector is inserted into a computer soundcard's microphone port, and the input mini-connector is inserted into a computer soundcard's speaker port.

4. A communications system comprising, in combination:
a computer;
a 2-way radio; and
a voice-activated transmitter Radio Interface Module which accepts digital signals from the computer and sends the audio signal over the radio system, and wherein a radio audio signal submitted to the voice-activated transmitter Radio Interface Module, the signal is reversed to the computer, and converted from analog to digital by the voice-activated transmitter Radio Interface Module.

5. A communications system according to claim 4, wherein the computer is programmed with a voice conference software which is typically used for two or more parties to voice communicate over the Internet which allows voice conference with audio devices such as a hand-held 800 MHZ radios, AM/FM radio or a television signal, whereby users can listen to audio signals from any location in which Internet access is available.

6. A communication system according to claim 5, further comprising:
a second computer;
a second 2-way radio;
a second voice-activated transmitter Radio Interface Module which accepts digital signals from the computer and sends the audio signal over the radio system, and wherein a radio audio signal submitted to the voice-activated transmitter Radio Interface Module, the signal is reversed to the computer, and converted from analog to digital by the voice-activated transmitter Radio Interface Module;
a first network connected to the first computer;
a second network connected to the second computer;
means for connecting the first network to the Internet; and
means for connecting the second network to the Internet, whereby someone communicating with the first 2-way radio can communicate with someone communicating with the second 2-way radio through the first voice-activated transmitter Radio Interface Module, the first computer, the first network, the Internet, the second network, the second computer and the second voice-activated transmitter Radio Interface Module.

7. A communication system according to claim 6 wherein the first network is a TCP/IP network and the second network is a TCP/IP network.

8. A method for communicating, comprising in combination the steps of:
programming a computer with a voice conference software which is typically used for two or more parties to voice communicate over the Internet;
communicating by means of a 2-way radio;
accepting digital data from the computer;
converting data from the computer to audio signals suitable for the 2-way radio;
sending the audio signals converted from the computer over the 2-way radio system;
accepting a radio audio signal from the 2-way radio;
converting from 2-way radio signal to data acceptable by the computer; and
transmitting the signal data received by the computer over the Internet by means of the voice conference software.

9. A method for communicating according to claim 8, further including the steps of:
transmitting AM radio or FM radio or a television signal or other audio signal over the Internet by means of the voice conference software.

10. A method for communicating according to claim 8, further including the steps of:
programming a second computer with the voice conference software which is typically used for two or more parties to voice communicate over the Internet;
receiving by the second computer the signal data transmitted by the first computer over the Internet by means of the voice conference software;
converting data from the second computer to audio signals suitable for a 2-way radio;
accepting digital data from the second computer;
sending the audio signals converted from the computer over a second 2-way radio system;
accepting a radio audio signal from the second 2-way radio;
converting from the second 2-way radio signal to data acceptable by the second computer; and
communicating by means of the second 2-way radio.
